(19) United States
(12) Patent Application Publication
(10) Pub. No.: US 2014/0298055 A1
(43) Pub. Date: Oct. 2, 2014

(54) ENERGY SAVING CIRCUIT OF COMPUTER

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: HAI-QING ZHOU, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/225,728

(22) Filed: Mar. 26, 2014

(30) Foreign Application Priority Data
Mar. 28, 2013 (CN) 2013101036449

(51) Int. Cl. G06F 1/32

(52) U.S. Cl. CPC G06F 1/32
USPC 713/320

(57) ABSTRACT

An energy saving circuit of a computer is connected between a power supply and a motherboard. The energy saving circuit includes first to fifth electronic switches and a sensor. When the computer is in a stand-by state and the sensor senses a person nearby, the motherboard of the computer receives a standby voltage and the motherboard maintains the stand-by state. When the sensor senses no one nearby, the motherboard does not receive the standby voltage and the motherboard is placed in a power off state.

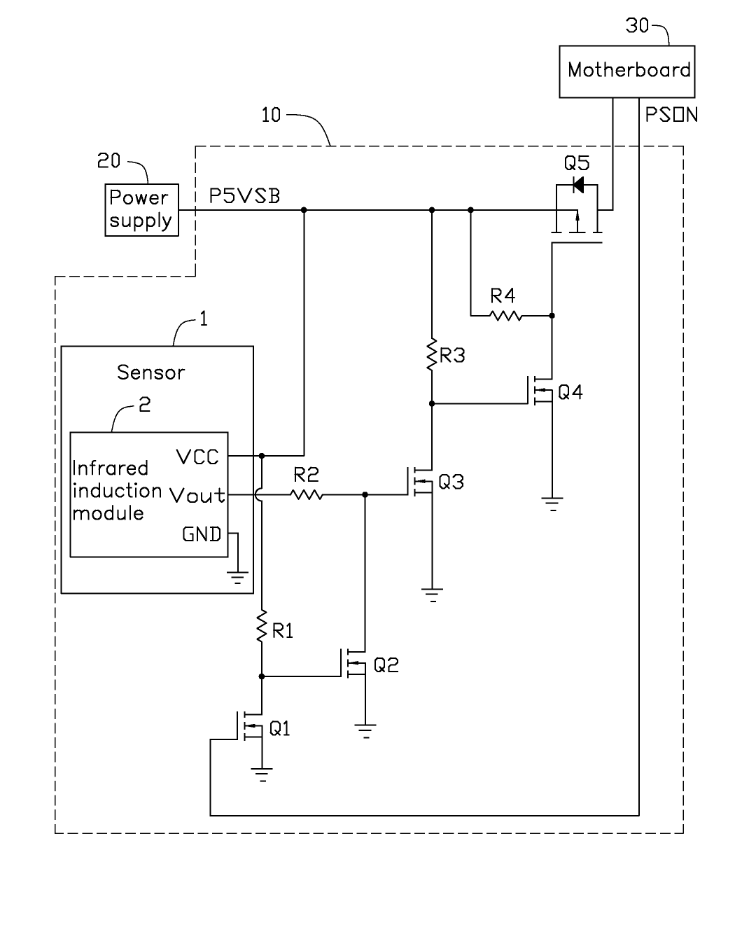

### FIELD

The present disclosure relates to an energy saving circuit.

### BACKGROUND

An electronic device, such as a computer is turned on and off by a switch that mechanically connects and disconnects a power supply of the computer to an external power source, such as AC 110V. The power supply is connected to the external power source and transforms an external voltage into predetermined DC voltages to allow the computer to perform various programs and functions. However, when the computer is powered off while still connected to the external power source, a 5V standby power is continuously received from the power supply, which is wasteful.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the presented embodiments.

The FIGURE is a circuit diagram of an embodiment of an energy saving circuit.

### DETAILED DESCRIPTION

The disclosure, including the FIGURE, is illustrated by way of example and not by way of limitation. References to “an” or “one” embodiment in this disclosure are not necessarily to the same embodiment, and such references mean “at least one”. Although discussion herein is directed to a computer, it will be understood the principles described can be utilized with other e-devices.

The FIGURE shows an embodiment of an energy saving circuit 10 connected between a power supply 20 and a motherboard 30. In the embodiment, the energy saving circuit 10 comprises a sensor 1, five electronic switches Q1-Q5, and four resistors R1-R4. In the embodiment, the sensor 1 comprises an infrared induction module 2, which comprises a power pin VCC, an output pin Vout, and a ground pin GND.

The power pin VCC of the infrared induction module 2 is connected to the power supply 20 to receive a standby voltage P5VSB. The ground pin GND of the infrared induction module 2 is grounded. In at least one embodiment, the output pin Vout of the infrared induction module 2 is utilized to output signals when a person nearby is sensed.

Each of the electronic switches Q1-Q5 includes a first terminal, a second terminal, and a third terminal. The first terminal of the electronic switch Q1 is connected to the motherboard 30 to receive a power-on signal PSON from the motherboard 30. The second terminal of the electronic switch Q1 is connected to the power pin VCC of the infrared induction module 2 through the resistor R1. The third terminal of the electronic switch Q1 is grounded. The first terminal of the electronic switch Q2 is connected to the second terminal of the electronic switch Q1. The second terminal of the electronic switch Q2 is connected to the output pin Vout of the infrared induction module 2 through the resistor R2. The third terminal of the electronic switch Q2 is grounded. The first terminal of the electronic switch Q3 is connected to the second terminal of the electronic switch Q2. The second terminal of the electronic switch Q3 is connected to the power supply 20 through the resistor R3 to receive the standby voltage P5VSB. The third terminal of the electronic switch Q3 is grounded. The first terminal of the electronic switch Q4 is connected to the second terminal of the electronic switch Q3. The second terminal of the electronic switch Q4 is connected to the power supply 20 through the resistor R4 to receive the standby voltage P5VSB. The third terminal of the electronic switch Q4 is grounded. The first terminal of the electronic switch Q5 is connected to the second terminal of the electronic switch Q4. The second terminal of the electronic switch Q5 is connected to the motherboard 30. The third terminal of the electronic switch Q5 is connected to the power supply 20 to receive the standby voltage P5VSB.

In at least one embodiment, when the computer is in a standby state, the motherboard outputs the power-on signal PSON at a high-level, such as logic 1 (hereinafter “high-level PSON signal”). When the computer is in a power-on state, the motherboard outputs the power-on signal PSON at a low-level, such as logic 0 (hereinafter “low-level PSON signal”).

When the computer is in the stand-by state, the motherboard 30 outputs the high-level PSON signal to the electronic switch Q1. The high-level PSON signal turns on the electronic switch Q1. When the electronic switch Q1 is turned on, the electronic switch Q2 is turned off. When the infrared induction module 2 senses a person nearby, the output pin Vout of the infrared induction module 2 outputs a low-level signal, such as logic 0, to the electronic switch Q3. The low-level signal turns off the electronic switch Q3. When the electronic switch Q3 is turned off, the electronic switch Q4 is turned on, and the electronic switch Q5 is turned on. When the electronic switch Q5 is turned on, the motherboard 30 receives the standby voltage P5VSB from the power supply 20 through the electronic switch Q5. Thus, the motherboard 30 is in a stand-by state.

When the infrared induction module 2 senses no one nearby, the output pin Vout of the infrared induction module 2 outputs a high-level signal, such as logic 1. The high-level signal turns on the electronic switch Q3. When the electronic switch Q3 is turned on, the electronic switch Q4 is turned off, and the electronic switch Q5 is turned off. When the electronic switch Q5 is turned off, the motherboard 30 cannot receive the standby voltage P5VSB from the power supply 20 through the electronic switch Q5. Thus, the motherboard 30 is in a power-off state.

When the computer is in a power-on state, the motherboard 30 outputs the low-level PSON signal to turn off the electronic switch Q1. When the electronic switch Q1 is turned off, the electronic switch Q2 is turned on. The first terminal of the electronic switch Q3 receives a low-level signal regardless of whether the output pin Vout of the infrared induction module 2 outputs a high or low-level signal, and the electronic switch Q3 is turned off. When the electronic switch Q3 is turned off, the electronic switch Q4 is turned on, and the electronic switch Q5 is turned on. The motherboard 30 receives the standby voltage P5VSB from the power supply 20 through the electronic switch Q5, and the motherboard 30 maintains a power on state.

In at least one embodiment, each of the electronic switches Q1-Q4 is an n-channel field effect transistor (FET), the electronic switch Q5 is a p-channel FET, and the first terminal, the second terminal, and the third terminal of each of the electronic switches Q1-Q5 are respectively a gate, a source, and a drain of the FET, respectively. In at least one embodiment, each of the electronic switches Q1-Q4 may be an npn bipolar junction transistor (BJT), electronic switch Q5 may be an pnp bipolar junction transistor BJT, and each of the electronic switches Q1-Q5 may be another switches having similar functions.

When the computer is in the stand-by state while the infrared induction module 2 senses a person nearby, the motherboard 30 of the computer receives the standby voltage P5VSB and the motherboard maintains the stand-by state. When the infrared induction module 2 senses no one nearby, the motherboard does not receive the standby voltage and is in a power off state for saving energy.

Even though numerous characteristics and advantages of the disclosure have been set forth in the foregoing description, together with details of the structure and function of the disclosure, the disclosure is illustrative only, and changes may be made in detail, including in the matters of shape, size, and arrangement of parts within the principles of the disclosure to the full extent indicated by the broad general meaning of the terms in which the appended claims are expressed.

What is claimed is:

1. An energy saving circuit connected between a power supply and a motherboard, the energy saving circuit comprising:
a sensor comprising a power pin connected to the power supply to receive a standby voltage, an output pint to output sensing signals, and a ground pin grounded; wherein when the sensor senses a person nearby, the output pin outputs a low-level signal, and when the sensor senses no one nearby, the output pin outputs a high-level signal;
a first resistor, a second resistor, a third resistor, and a fourth resistor;
a first electronic switch comprising a first terminal connected to the motherboard to receive a power on signal from the motherboard, a second terminal connected to the power pin of the sensor through the first resistor, and a third terminal grounded; wherein the second terminal of the first electronic switch is connected to the third terminal of the first electronic switch, in response to the first terminal of the first electronic switch receiving a high-level signal; the second terminal of the first electronic switch is disconnected from the third terminal of the first electronic switch, in response to the first terminal of the first electronic switch receiving a low-level signal;
a second electronic switch comprising a first terminal connected to the second terminal of the first electronic switch, a second terminal connected to the output pin of the sensor through the second resistor, and a third terminal grounded; wherein the second terminal of the second electronic switch is connected to the third terminal of the second electronic switch, in response to the first terminal of the second electronic switch receiving a high-level signal; the second terminal of the second electronic switch is disconnected from the third terminal of the second electronic switch, in response to the first terminal of the second electronic switch receiving a low-level signal;
a third electronic switch comprising a first terminal connected to the second terminal of the second electronic switch, a second terminal connected to the power supply to receive the standby voltage through the third resistor, and a third terminal ground; wherein the second terminal of the third electronic switch is connected to the third terminal of the third electronic switch, in response to the first terminal of the third electronic switch receiving a high-level signal; the second terminal of the third electronic switch is disconnected from the third terminal of the third electronic switch, in response to the first terminal of the third electronic switch receiving a low-level signal;
a fourth electronic switch comprising a first terminal connected to the second terminal of the third electronic switch, a second terminal connected to the power supply to receive the standby voltage through the fourth resistor, and a third terminal ground; wherein the second terminal of the fourth electronic switch is connected to the third terminal of the fourth electronic switch, in response to the first terminal of the fourth electronic switch receiving a high-level signal; the second terminal of the fourth electronic switch is disconnected from the third terminal of the fourth electronic switch, in response to the first terminal of the fourth electronic switch receiving a low-level signal; and
a fifth electronic switch comprising a first terminal connected to the second terminal of the fourth electronic switch, a second terminal connected to the motherboard, and a third terminal connected to the power supply to receive the standby voltage; wherein the second terminal of the fifth electronic switch is connected to the third terminal of the fifth electronic switch, in response to the first terminal of the fifth electronic switch receiving a low-level signal; the second terminal of the fifth electronic switch is disconnected from the third terminal of the fifth electronic switch, in response to the first terminal of the fifth electronic switch receiving a high-level signal.

2. The energy saving circuit of claim 1, wherein the sensor is an infrared induction module.

3. The energy saving circuit of claim 1, wherein the first to fourth electronic switches are n-channel field effect transistors (FETs), the first to third terminals of the first to fourth electronic switches correspond to gates, sources, and drains of the FETs.

4. The energy saving circuit of claim 1, wherein the fifth electronic switch is p-channel field effect transistor (FET), the first to third terminals of the fifth electronic switch correspond to gate, source, and drain of the FET.
